(19) United States
(12) Patent Application Publication
(10) Pub. No.: US 2007/0159522 A1
(43) Pub. Date: Jul. 12, 2007

(54) IMAGE-BASED CONTEXTUAL ADVERTISEMENT METHOD AND BRANDED BARCODES

(76) Inventor: Harmut Neven, Malibu, CA (US)

Correspondence Address: GOOGLE / FENWICK, SILICON VALLEY CENTER, 801 CALIFORNIA ST., MOUNTAIN VIEW, CA, 94041, US

(21) Appl. No.: 11/608,219

(22) Filed: Dec. 7, 2006

Related U.S. Application Data
(63) Continuation-in-part of application No. 11/433,052, filed on May 12, 2006.
(63) Continuation-in-part of application No. 11/129,034, filed on May 13, 2005.
(63) Continuation-in-part of application No. 10/783,378, filed on Feb. 20, 2004.
(60) Provisional application No. 60/742,964, filed on Dec. 7, 2005.
(60) Provisional application No. 60/727,313, filed on Oct. 17, 2005.
(60) Provisional application No. 60/680,908, filed on May 13, 2005.
(60) Provisional application No. 60/570,924, filed on May 13, 2004.

(51) Int. Cl. H04N 7/14

(52) U.S. Cl. 348/14.02; 358/1.15; 701/213

(57) ABSTRACT

Content media having images associated with remotely stored information are provided with barcodes marked with indicia to indicate a source of the information. In this manner, a user, having, for example, a camera phone, will become aware that the particular content medium has images that can be scanned to retrieve additional information (from the remote information store) via their camera phone.

### CROSS-REFERENCE TO RELATED APPLICATIONS

The present application claims priority, under 35 U.S.C. § 119, of U.S. Provisional Patent Application No. 60/742,964, filed on Dec. 7, 2005 and entitled “Image-Based Contextual Advertisement Method and Branded Barcodes”. Further, the present application is a continuation-in-part, under 35 U.S.C. § 120, of U.S. patent application Ser. No. 11/433,052, filed on May 12, 2006 and entitled “Mobile Image-Based Information Retrieval System”, which claims priority of U.S. Provisional Patent Application No. 60/727,313, filed on Oct. 17, 2005 and entitled “Mobile Image-Based Information Retrieval System”, and U.S. Provisional Patent Application No. 60/680,908, filed on May 13, 2005 and entitled “Mobile Image-Based Information Retrieval System”, and which is a continuation-in-part of U.S. patent application Ser. No. 11/129,034, filed on May 13, 2005 and entitled “Image-Based Search Engine For Mobile Phones With Camera”, which claims priority of U.S. Provisional Patent Application No. 60/570,924, filed on May 13, 2004 and entitled “Improved Image-Based Search Engine For Mobile Phones With Camera”, and which is a continuation-in-part of U.S. patent application Ser. No. 10/783,378, filed on Feb. 20, 2004 and entitled “Image-Based Inquiry System For Search Engines For Mobile Telephones With Integrated Camera”.

### BACKGROUND

Almost all modern mobile phones come with an integrated camera or image capture device (such phones often being referred to as “camera phones”). The camera is typically used for taking pictures for posterity purposes (e.g., taking still shots of a particular scene).

### SUMMARY

According to at least one aspect of one or more embodiments of the present invention, content media having images associated with remotely stored information are provided with barcodes marked with indicia to indicate a source of the information. In this manner, a user, having, for example, a camera phone, will become aware that the particular content medium has images that can be scanned to retrieve additional information (from the remote information store) via their camera phone.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

FIG. 1 is a figure illustrating the main components of a Visual Mobile Search (VMS) Service in accordance with an embodiment of the present invention.

FIG. 2 is a figure illustrating the population of a database of a VMS server with image content pairs in accordance with an embodiment of the present invention.

FIG. 3 is a figure illustrating the process of retrieving mobile content from a media server through visual mobile search in accordance with an embodiment of the present invention.

FIG. 4 is a figure illustrating an effective recognition server in accordance with an embodiment of the present invention.

FIG. 5 is a block diagram of an image-based information retrieval system in accordance with an embodiment of the present invention.

FIG. 6 is a flow diagram for an operation of an object recognition engine in accordance with an embodiment of the present invention.

FIG. 7 illustrates an example of an intelligent museum guide implemented using the VMS service in accordance with an embodiment of the present invention.

FIG. 8 illustrates an example of how VMS may be used as a tool for a tourist to access relevant information based on an image in accordance with an embodiment of the present invention.

FIG. 9 illustrates an example of how VMS may be used in using traditional print media as pointers to interactive content in accordance with an embodiment of the present invention.

FIGS. 10-11 illustrate the use of the VMS client in accordance with an embodiment of the present invention.

FIG. 12 illustrates an exemplary web page having an image with objects in accordance with an embodiment of the present invention.

FIG. 13 illustrates recognized objects in the web page of FIG. 1.

FIG. 14 illustrates a flow chart of a method for presenting image-based contextual advertisements in accordance with an embodiment of the present invention.

FIG. 15 illustrates an exemplary web page having image-based contextual advertisements in accordance with an embodiment of the present invention.

FIGS. 16-25 illustrate branded barcodes in accordance with one or more embodiments of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

One or more embodiments exploit the eminent opportunity that mobile phones with inbuilt camera are proliferating at a rapid pace. Driven through the low cost of cameras the percentage of camera phones of all mobile phones is rapidly increasing as well. The expectation is that in a few years in the order of one billion mobile handsets with cameras will be in use worldwide.

This formidable infrastructure may be used to establish a powerful image-based search service, which functions by sending an image acquired by a camera phone to a server. The server hosts visual recognition engines that recognize the objects shown in the image and that returns search results in appropriate format back the user.

The disclosure herein also describes in detail the realization of the overall system architecture as well the heart of the image-based search service, the visual recognition engines. The disclosure lists multiple inventions on different levels of the mobile search system that make it more conducive to successful commercial deployments.

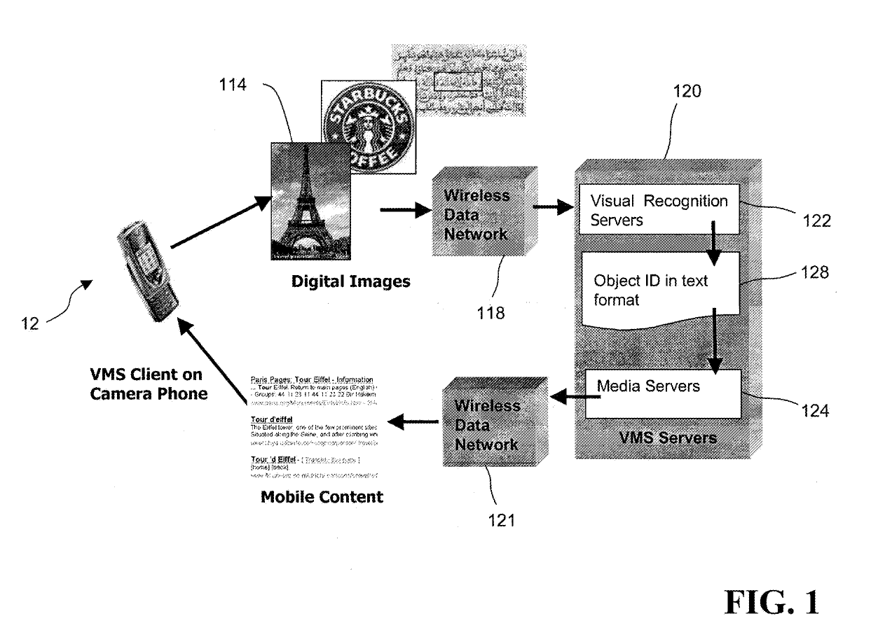

A visual mobile search (VMS) service in accordance with one or more embodiments is designed to offer a powerful new functionality to mobile application developers and to the users of mobile phones. Referring to FIG. 1, mobile phone users can use the inbuilt camera of a mobile phone 12 to take a picture 114 of an object of interest and send it via a wireless data network 118 such as, for example, the GPRS network to the VMS server 120. The object gets recognized and upon recognition the servers will take the action the application developer requested. Typically this entails referring the sender to a URL with mobile content 121 designed by the application developer but can entail more complex transactions as well.

The VMS server 120 may be thought of as having two components. A visual recognition server 122, also sometimes referred to as the object recognition (OR) server, recognizes an object within an image, interacts with a media server 124 to provide content to the client, and stores new objects in a database. The media server 124 is responsible for maintaining content associated with a given ID and delivering the content to a client. The media server 124 may also provide a web interface for changing content for a given object.

A VMS client piece is responsible for running the VMS client to send images and receive data from the server. The VMS client is either pre-installed on the phone or comes as an over-the-air update in, for example, a Java or BREW implementation. Alternatively, the communication between the phone and the recognition servers is handled via multimedia messaging (MMS). FIG. 1 illustrates the main components of the Visual Mobile Search Service.

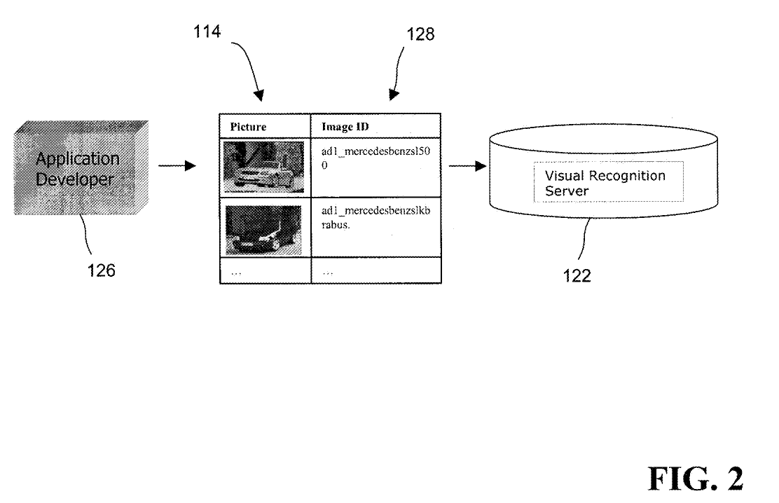

To make use of VMS service, the application developer submits a list of pictures and associated image IDs in textual format to the visual recognition server. Referring to FIG. 2, an application developer 126, which can occasionally be an end user himself, submits images 114 annotated with textual IDs 128 to the recognition servers 122. FIG. 2 illustrates the population of the database with image content pairs.

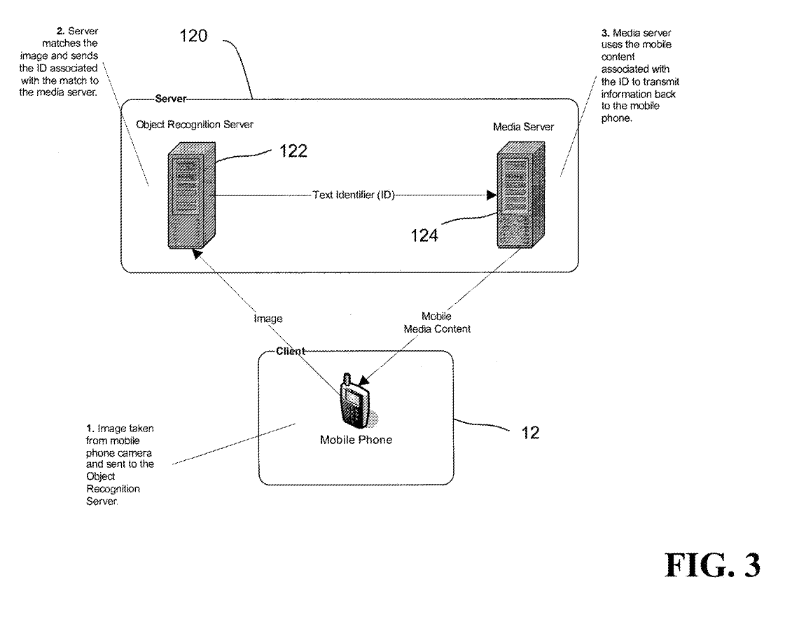

FIG. 3 shows in more detail the steps involved in retrieving mobile content and how the system refers an end user to the mobile content. Initially, the user takes an image with his camera phone 12 and sends it to the recognition server 122. This can either be accomplished by using a wireless data network such as GPRS, or it may be sent via multi media messaging MMS as this is supported by most wireless carriers. Then, the recognition server 122 uses its multiple recognition engines to match the incoming picture against object representation stored in its database. In one or more embodiments, multiple recognition experts may be used, where each specializes in recognizing certain classes of patterns. For example, a facial recognition engine is good for recognizing textured objects. Optical character recognizers and barcode readers try to identify text strings or barcodes. A more detailed description of the recognition engines is given below. Successful recognition leads to a single or several textual identifiers denoting object, faces, or strings that are passed on to media server 124. Upon receipt of the text strings, the media server 124 sends associated mobile multimedia content back to the VMS client on the phone. This content could consist of a mix of data types such as text, images, music or audio clips. In one or more embodiments, the media server 124 may send back a URL that can be viewed on the phone using an inbuilt web browser.

Further, it is notes that the content may consist of a URL that is routed to the browser on the phone, which can then be used to open the referenced mobile webpage through standard mobile web technology.

Years of experience in machine vision have shown that it is very difficult to design a recognition engine that is equally well suited for diverse recognition tasks. For instance, engines exist that are well suited to recognize well textured rigid objects. Other engines are useful to recognize deformable objects such as faces or articulate objects such as persons. Yet other engines are well suited for optical character recognition. To implement an effective vision-based search engine it will be important to combine multiple algorithms in one recognition engine or alternatively install multiple specialized recognition engines that analyze the query images with respect to different objects.

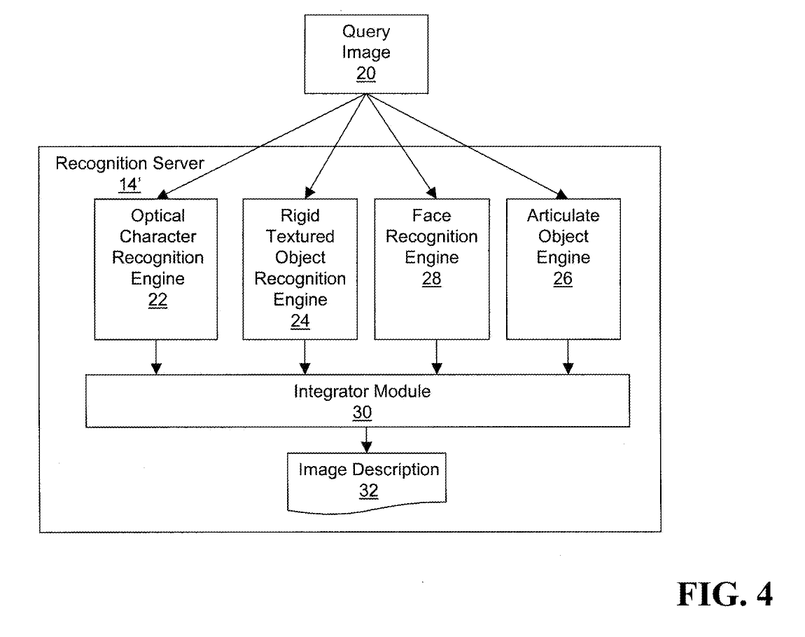

In one or more embodiments, multiple recognition engines are applied to an incoming image. Each engine returns the recognition results with confidence values and an integrating module that outputs a final list of objects recognized. The simplest fusion rule is a rule that simply sends all the relevant textual IDs to the media server. Another useful rule if one wants to reduce the feedback to a single result is to introduce a hierarchy among the recognition disciplines. The channel which is highest in the hierarchy and which returns a result is selected to forward the text ID to the media server. FIG. 4 shows an effective recognition server 14′ that is comprised of multiple specialized recognition engines 22, 24, 28, 26 that focus on recognizing certain object classes.

It is noted that it is important to regularly update the object representations because objects change over time and/or space. This may be achieved in at least two ways. One way is that the service providers regularly add current image material to refresh the object representations. The other way is to keep the images that users submit for query and upon recognition feed them into the engine that updates the object representations. The later method may require a confidence measure that estimates how reliable a recognition result is. This may be necessary in order not to pollute the database. There are different ways to generate such a confidence measure. One is to use match scores, topological and other consistency checks that are intrinsic to the object recognition methods described below. Another way is to rely on extrinsic quality measures such as to determine whether a search result was accepted by a user. This can with some reliability be inferred from whether the user continued browsing the page to which the search result led and/or whether he did not do a similar query shortly after.

To facilitate object recognition, it is important to cut down the number of object representations against which the incoming image has to be compared. Often one has access to other information in relation to the image itself. Such information can include time, location of the handset, user profile or recent phone transactions. Another source of external image information is additional inputs provided by the user.

It may be beneficial to make use of this information to narrow down the search. For instance, if one attempts to get information about a hotel by taking a picture of its facade and knows it is 10 pm in the evening than it will increase the likelihood of correct recognition if one selects from the available images those that have been taken close to 10 pm. The main reason is that the illumination conditions are likely to be more similar.

Location information may also be used. Staying with the hotel example, one would arrange the search process such that only object representations of hotels are activated in the query of hotels that are close to the current location of the user.

Overall it will be helpful to organize the image search such that objects are looked up in a sequence in which object representations close in time and space will be searched before object representations that are older, were taken at a different time of day or carry a location label further away are considered.

One implementation of a search engine is one in which the recognition engine resides entirely on the server. However, it may be desirable to run part of the recognition process on the phone. One reason is that this way the server has less computational load and the service can be run more economically. The second reason is that the feature vectors contain less data then the original image thus the data that needs to be send to the server can be reduced.

Another way to keep the processing more local on the handset is to store the object representations of the most frequently requested objects locally on the handset. Information on frequently requested searches can be obtained on an overall, group or individual user level.

To recognize an object in a reliable manner, sufficient image detail needs to be provided. In order to strike a good balance between the desire for a low bandwidth and a sufficiently high image resolution, one can use a method in which a lower resolution representation of the image is sent first. If necessary and if the object recognition engines discover a relevant area that matches well one of the existing object representations, one can transmit additional detail.

For a fast proliferation of the search service, it will be important to allow a download over the air of the client application. The client side application would essentially acquire an image and send appropriate image representations to recognition servers. It then would receive the search results in an appropriate format. Advantageously, such an application may be implemented in Java or BREW so that it is possible to download this application over the air instead of preloading it on the phone.

In one or more embodiments, it may be helpful to provide additional input to limit the image-based search to specific domains such as “travel guide” or “English dictionary”. External input to confine the search to specific domains can come from a variety of sources. One is of course text input via typing or choosing from a menu of options. Another one is input via Bluetooth or other signals emitted from the environment. A good example for the later might be a car manual. While the user is close to the car for which the manual is available, a signal is transmitted from the car to his mobile device that allows the search engine to offer a specific search tailored to car details. Moreover, a previous successful search can cause the search engine to narrow down search for a subsequent search.

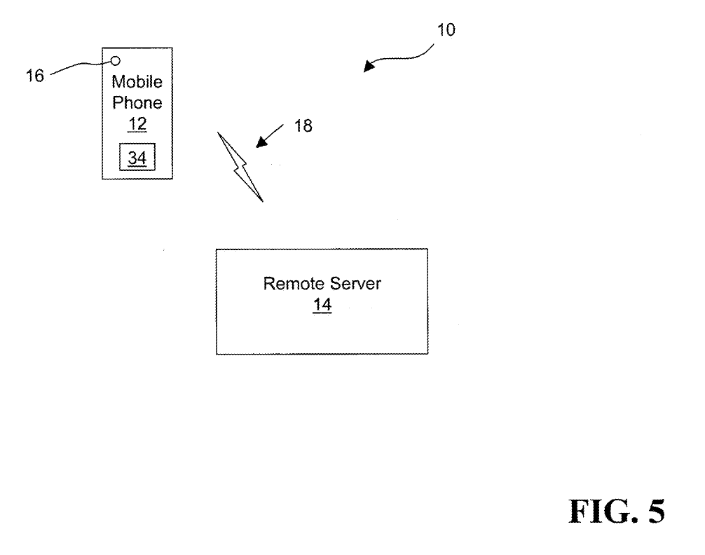

Accordingly, with reference to FIG. 5, one or more embodiments may be embodied in an image-based information retrieval system 10 including a mobile telephone 12 and a remote server 14. The mobile telephone has a built-in camera 16, a recognition engine 32 for recognizing an object or feature in an image from the built-in camera, and a communication link 18 for requesting information from the remote server 14 related to a recognized object or feature.

Accordingly, with reference to FIGS. 4 and 5, one or more embodiments may be embodied in an image-based information retrieval system that includes a mobile telephone 12 and a remote recognition server 14′. The mobile telephone has a built-in camera 16 and a communication link 18 for transmitting an image 20 from the built-in camera to the remote recognition server. The remote recognition server has an optical character recognition engine 22 for generating a first confidence value based on an image from the mobile telephone, an object recognition engine, 24 and/or 26, for generating a second confidence value based on an image from the mobile telephone, a face recognition engine 28 for generating a third confidence value based on an image from the mobile telephone, and an integrator module 30 for receiving the first, second, and third confidence values and generating a recognition output. The recognition output may be an image description 32.

As described above, the VMS system has a suite of recognition engines that can recognize various visual patterns from faces to barcodes.

A general object recognition engine may learn to recognize an object from a single image. If available, the engine may also be trained with several images from different viewpoints or a short video sequence which often contributes to improving the invariance under changing viewing angle. In this case, one may invoke the view fusion module that is discussed in more detail below.

From a usability standpoint, it is important to allow a user, who is not a machine vision expert, to easily submit entries to the library of objects that can be recognized. A good choice to implement such a recognition engine is based on the SIFT feature approach described by David Lowe in 1999. Essentially, it allows recognition an object based on a single picture.

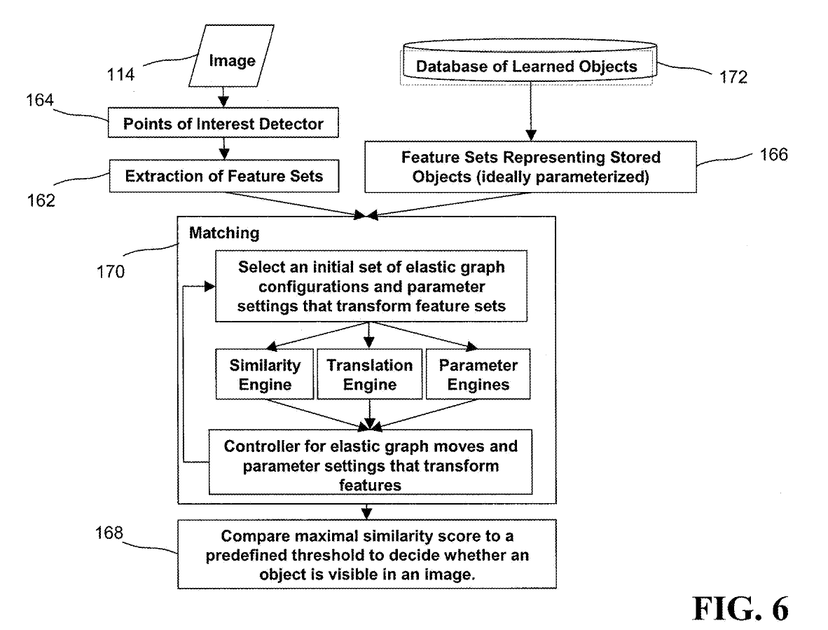

Referring to FIG. 6, macro algorithmic principles of the object recognition engine are: extraction of feature vectors 162 from key interest points 164, comparison 168 of corresponding feature vectors 166, similarity measurement and comparison against a threshold to determine if the objects are identical or not.

Sub modules may be used for additional or improved features. With an interest operator, using phase congruency of Gabor wavelets may be superior to many other interest point operators suggested in the literature such as affine Harris or DOG Laplace (Kovesi 1999). As to feature vectors, instead of Lowe's SIFT features, Gabor wavelets may be used as a powerful general purpose data format to describe local image structure. However, where appropriate, they may be augmented with learned features reminiscent of the approach pioneered by Viola and Jones (Viola and Jones 1999). Finally, a dictionary of parameterized sets of feature vectors extracted from massive of image data sets that show variations under changing viewpoint and lighting conditions of generic surface patches (“Locons”) may be used.

As to matching 170, displacement vectors as well as parameter sets that describe environmental conditions such as viewpoint and illumination conditions may be explicitly estimated. This may be achieved by considering the phase information of Gabor wavelets or through training of dedicated neural networks. Thus, one or more embodiments may more rapidly learn new objects and recognize them under a wider range of conditions than anyone else. Further, embedded recognition systems may be used. The recognition algorithms are available for various DSPs and microprocessors.

In one or more embodiments, to support the recognition of objects from multiple viewpoints, feature linking is applied to enable the use of multiple training images for each object to completely cover a certain range of viewing angles. If one uses multiple training images of the same object without modification of the algorithm, the problem of competing feature datasets arises. The same object feature might be detected in more than one training image if these images are taken from a sufficiently similar perspective. The result is that any given feature can be present as multiple datasets in the database. Because any query feature can be matched to only one of the feature datasets in the database, some valid matches will be missed. This will lead to more valid hypotheses, since there are multiple matching views of the object in the database, but with fewer matches per hypothesis, which will diminish recognition performance. To avoid this degradation in performance, feature datasets may be linked so that all data sets of any object feature will be considered in the matching process.

To achieve the linking, the following exemplar procedure can be used. When enrolling a training image into the database, all features detected in this image will be matched against all features in each training image of the same object already enrolled in the database. The matching is done in the same way that the object recognition engine deals with probe images, except that the database is comprised of only one image at a time. If a valid hypothesis is found, all matching feature datasets are linked. If some of these feature datasets are already linked to other feature datasets, these links are propagated to the newly linked feature datasets, thus establishing networks of datasets that correspond to the same object feature. Each feature datasets in the network will have links to all other feature datasets in the network.

When matching a probe image against the database 172, in addition to the direct matches, all linked feature datasets will be considered valid matches. This may significantly increase the number of feature matches per hypothesis and boost recognition performance at very little computational cost.

In one or more embodiments, an efficient implementation of a search service may require that the image search is organized such that it scales logarithmically with the number of entries in the database. This can be achieved by conducting a coarse-to-fine simple to complex search strategy such as described in (Beis and Lowe, 1997). The principal idea is to do the search in an iterative fashion starting with a reduced representation that contains only the most salient object characteristics. Only matches that result from this first pass are investigated closer by using a richer representation of the image and the object. Typically this search proceeds in a couple of rounds until a sufficiently good match using the most complete image and object representation is found.

To cut down the search times further, color histograms and texture descriptors such as those proposed under the MPEG7 standard may be used. These image descriptors can be computed very rapidly and help to readily identify subsets of relevant objects. For instance, a printed text tends to generate characteristic color histograms and shape descriptors. Thus, it might be useful to limit the initial search to character recognition if those descriptors lie within a certain range.

A face recognition engine described in (U.S. Pat. No. 6,301,370 FACE RECOGNITION FROM VIDEO IMAGES, Oct. 9, 2001, Maurer Thomas, Elagin, Egor Valerievich, Nocera Luciano Pasquale Agostino, Steffens, Johannes, Bernhard, Neven, Hartmut) also allows to add new entries into the library using small sets of facial images. This system may be generalized to work with other object classes as well.

Adding additional engines such as optical character recognition modules and barcode readers allows for a yet richer set of visual patterns to be analyzed. Off-the-shelf commercial systems are available for licensing to provide this functionality.

Let us start the discussion of the usefulness of image-based search with an anecdote. Imagine you are on travel in Paris and you visit a museum. If a picture catches your attention you can simply take a photo and send it to the VMS service. Within seconds you will receive an audio-visual narrative explaining the image to you. If you happen to be connected a 3G network the response time would be below a second. After the museum visit you might step outside and see a coffeehouse. Just taking another snapshot from within the VMS client application is all you have to do in order to retrieve travel guide information. In this case location information is available through triangulation or inbuilt GPS it can assist the recognition process. Inside the coffeehouse you study the menu but your French happens to be a bit rusty. Your image based search engine supports you in translating words from the menu so that you have at least an idea of what you can order.

This anecdote could of course easily be extended further. Taking a more abstract viewpoint one can say that image-based search hyperlinks the physical world in that any recognizable object, text string, logo, face, etc. can be annotated with multimedia information.

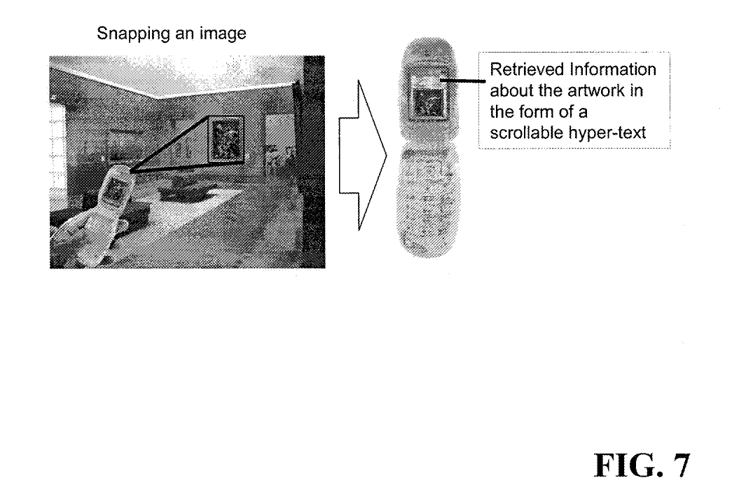

In the specific case of visiting and researching the art and architecture of museums, image-based information access, can provide the museum visitors and researchers with the most relevant information about the entire artwork or parts of an artwork in a short amount of time. The users of such a system can conveniently perform image-based queries on the specific features of an artwork, conduct comparative studies, and create personal profiles about their artworks of interest. FIG. 7 illustrates an example of the intelligent museum guide, where on the left side user has snapped an image of the artwork of his/her interest and on the right side the information about the artwork is retrieved from the server. In addition, users can perform queries about specific parts of an artwork not just about the artwork as a whole. The system works not only for paintings but for almost any other object of interest as well: statues, furniture, architectural details or even plants in a garden.

The proposed image-based intelligent museum guide is much more flexible than previously available systems, which for example perform a pre-recorded presentation based on the current position and orientation of the user in museum. In contrast, our proposed Image-Based Intelligent Museum Guide has one or more of the following unique characteristics: 1—users can interactively perform queries about different aspects of an artwork. For example, as shown in FIG. 2, a user can ask queries such as: “Who is this person in the cloud?”. Being able to interact with the artworks will make the museum visit a stimulating and exciting educational experience for the visitors, specifically the younger ones; 2—visitors can keep a log of the information that they asked about the artworks and cross-reference them; 3—visitors can share their gathered information with their friends; 4—developing an integrated global museum guide is possible; 5—no extra hardware is necessary as many visitors carry cell-phones with inbuilt camera; and 6—the service can be a source of additional income where applicable.

Presentation of the retrieved information will also be positively impacted by the recognition ability of the proposed system. Instead of having a ‘one explanation that fits all’ for an artwork, it is possible to organize the information about different aspects of an artwork in many levels of details and to generate a relevant presentation based on the requested image-based query. Dynamically generated presentations may include still images and graphics, overlay annotations, short videos and audio commentary and can be tailored for different age groups, and users with various levels of knowledge and interest.

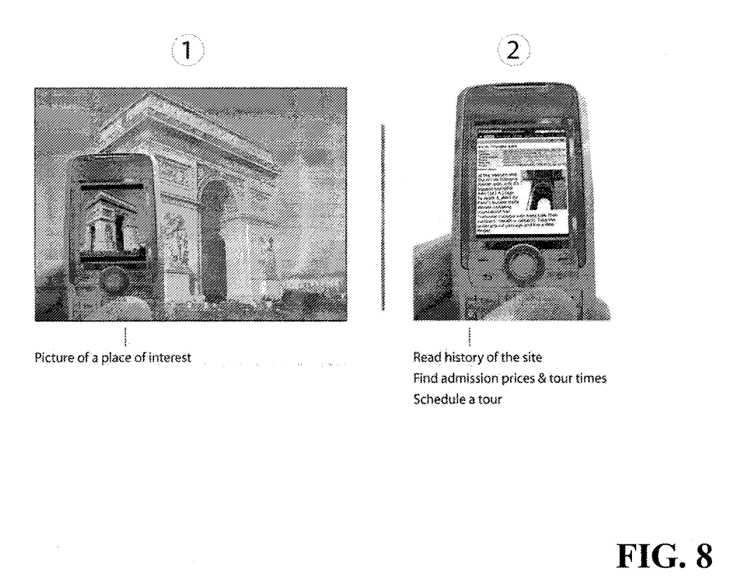

The museum application can readily be extended to other objects of interest to a tourist: landmarks, hotels, restaurants, wine bottles etc. It is also noteworthy that image-based search can transcend language barriers, and not just by invoking explicitly an optical character recognition subroutine. The Paris coffeehouse example would work the same way with a sushi bar in Tokyo. It is not necessary to know Japanese characters to use this feature. FIG. 8 illustrates how VMS may be used as a tool for a tourist to quickly and comfortably access relevant information based on an acquired image.

A specific application of the image-based search engine is recognition of words in a printed document. The optical character recognition sub-engine can recognize a word which then can be handed to an encyclopedia or dictionary. In case the word is from a different language than the user's preferred language a dictionary look-up can translate the word before it is processed further.

Image-based search can support new print-to-Internet applications. If you see a movie ad in a newspaper or on a billboard you can quickly find out with a single click in which movie theaters it will show.

Image-based mobile search can totally alter the way how many retail transactions are done. To buy a Starbucks coffee on your way to the airplane simply click on a Starbucks ad. This click brings you to the Starbucks page, a second click specifies your order. That is all you will have to do. You will be notified via a text message that your order is ready. An integrated billing system took care of your payment.

A sweet spot for a first commercial roll-out is mobile advertising. A user can send a picture of a product to a server that recognizes the product and associates the input with the user. As a result the sender could be entered into a sweepstake or he could receive a rebate. He could also be guided to a relevant webpage that will give him more product information or would allow him to order this or similar products.

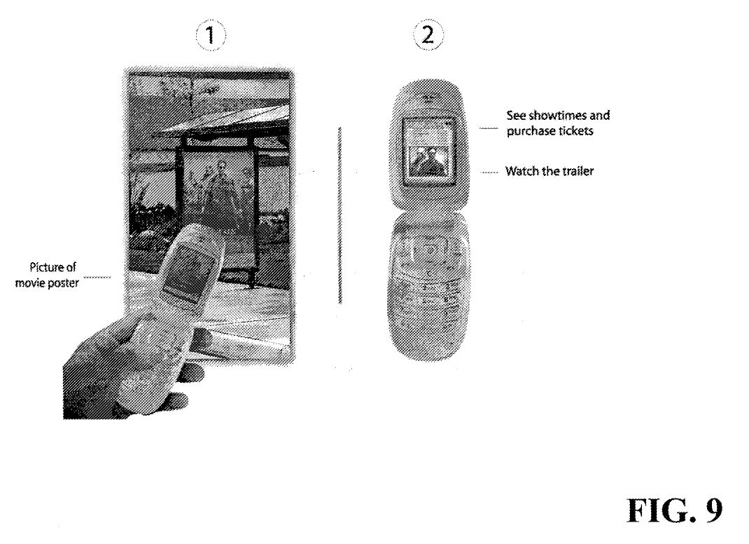

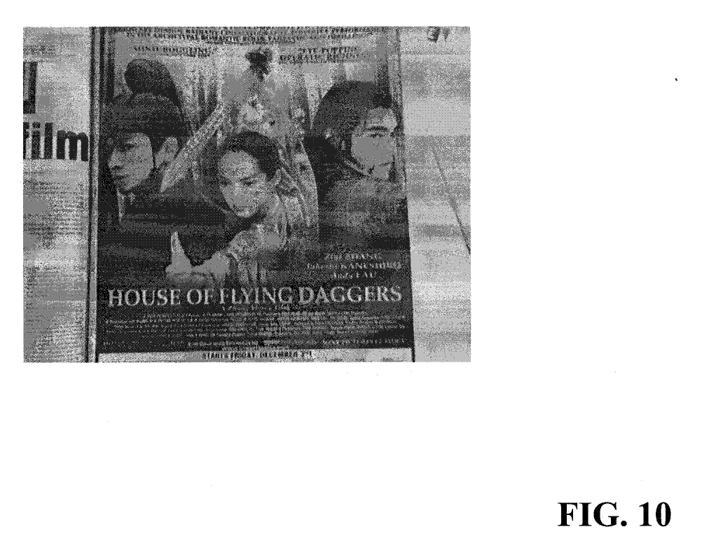

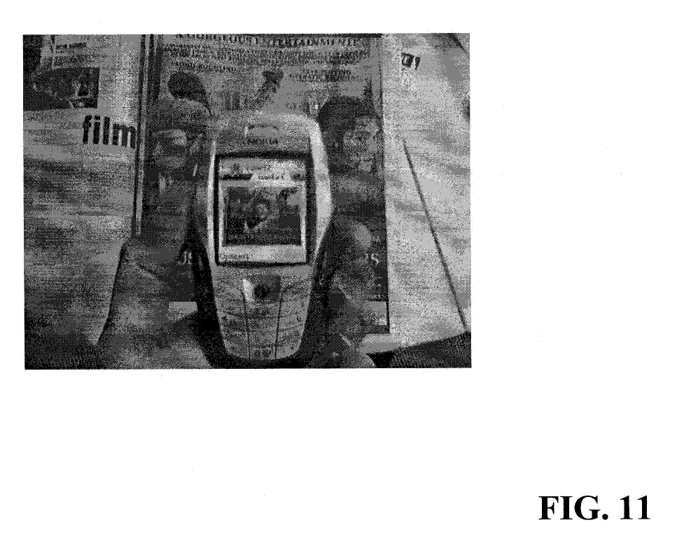

Image-based search using a mobile phone is so powerful because the confluence of location, time, and user information with the information from a visual often makes it simple to select the desired information. The mobile phone naturally provides context for the query. FIG. 9 illustrates how VMS allows using traditional print media as pointers to interactive content.

Another useful application of image-based search exists in the print-to-internet space. By submitting a picture showing a portion of a printed page to a server a user can retrieve additional, real-time information about the text. Thus together with the publishing of the newspaper, magazine or book it will be necessary to submit digital pictures of the pages to the recognition servers so that each part of the printed material can be annotated. Since today's printing process in large parts starts from digital versions of the printed pages this image material is readily available. In fact it will allow using printed pages in whole new ways as now they could be viewed as mere pointers to more information that is available digitally.

A special application is an ad-to-phone number feature that allows a user to quickly input a phone number into his phone by taking a picture of an ad. Of course a similar mechanism would of useful for other contact information such as email, SMS or web addresses.

Visual advertising content may be displayed on a digital billboard or large television screen. A user may take of picture of the billboard and the displayed advertisement to get additional information about the advertised product, enter a contest, etc. The effectiveness of the advertisement can be measured in real time by counting the number of “clicks” the advertisement generates from camera phone users. The content of the advertisement may be adjusted to increase its effectiveness based on the click rate.

The billboard may provide time sensitive advertisements that are target to passing camera phone users such as factory workers arriving leaving work, parents picking up kids from school, or the like. The real-time click rate of the targeted billboard advertisements may confirm or refute assumptions used to generate the targeted advertisement.

Image recognition can also be beneficially integrated with a payment system. When browsing merchandise a customer can take a picture of the merchandise itself, of an attached barcode, of a label or some other unique marker and send it to the server on which the recognition engine resides. The recognition results in an identifier of the merchandize that can be used in conjunction with user information, such as his credit card number to generate a payment. A record of the purchase transaction can be made available to a human or machine-based controller to check whether the merchandise was properly paid.

A group of users in constant need for additional explanations are children. Numerous educational games can be based on the ability to recognize objects. For example one can train the recognition system to know all countries on a world map. Other useful examples would be numbers or letters, parts of the body etc. Essentially a child could read a picture book just by herself by clicking on the various pictures and listen to audio streams triggered by the outputs of the recognition engine.

Other special needs groups that could greatly benefit from the VMS service are blind and vision impaired people.

Object recognition on mobile phones can support a new form of games. For instance a treasure hunt game in which the player has to find a certain scene or object say the facade of a building. Once he takes the picture of the correct object he gets instructions which tasks to perform and how to continue.

Image-based search will be an invaluable tool to the service technician, who wants more information about a part of a machine; he now has an elegant image query based user manual.

Image-based information access facilitates the operation and maintenance of equipment. By submitting pictures of all equipment parts to a database, the service technicians will continuously be able to effortlessly retrieve information about the equipment they are dealing with. Thereby they drastically increase their efficiency in operating gear and maintenance operations.

Another important area is situations in which it is too costly to provide desired real-time information. Take a situation as profane as waiting for a bus. Simply by clicking on the bus stop sign you could retrieve real-time information on when the next bus will come because the location information available to the phone is often accurate enough to decide which bus stand you are closest to.

A user can also choose to use the object recognition system in order to annotate objects in way akin to “Virtual Post-it Notes”. A user can take a photo of an object and submit it to the database together with a textual annotation that he can retrieve later when taking a picture of the object.

Another important application is to offer user communities the possibility to upload annotated images that support searches that serve the needs of the community. To enable such use cases that allow users who are not very familiar with visual recognition technology to submit images used for automatic recognition one needs take precautions that the resulting databases are useful. A first precaution is to ensure that images showing identical objects are not entered under different image IDs. This can be achieved by running a match for each newly entered image against the database that already exists.

To offer the image based search engine in an economically viable fashion, various business models may be offered as described below. The VMS service may be offered on a transaction fee basis. When a user queries the service at transaction fee applies. Of course individual transaction fees can be aggregated in to a monthly flat rate. Typically the transaction fee is paid by the user or is sponsored by say advertisers.

To entice users to submit interesting images to the recognition service, one may put in place programs that provide for revenue sharing with the providers of annotated image databases.

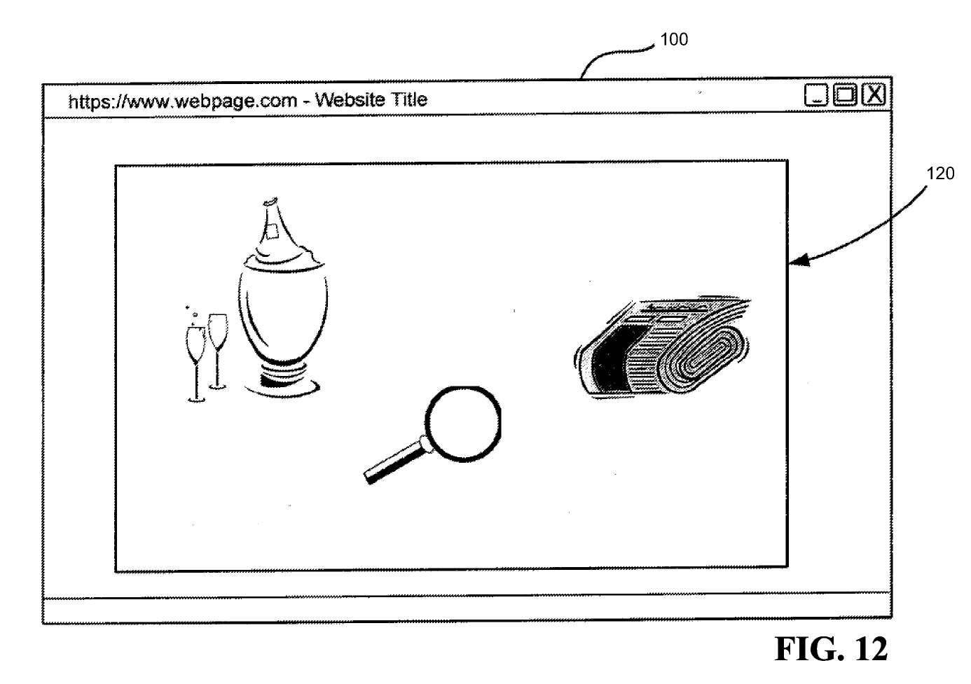

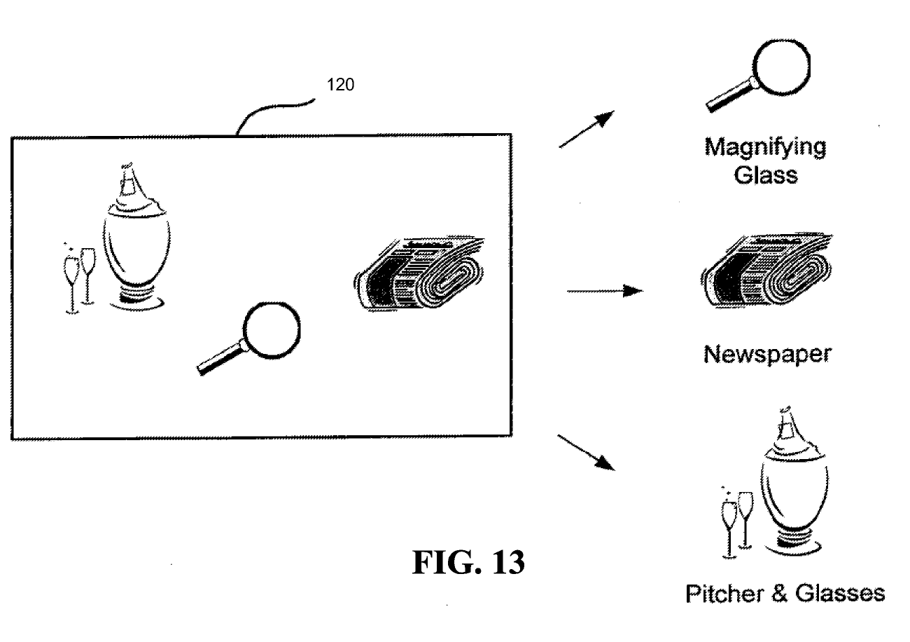

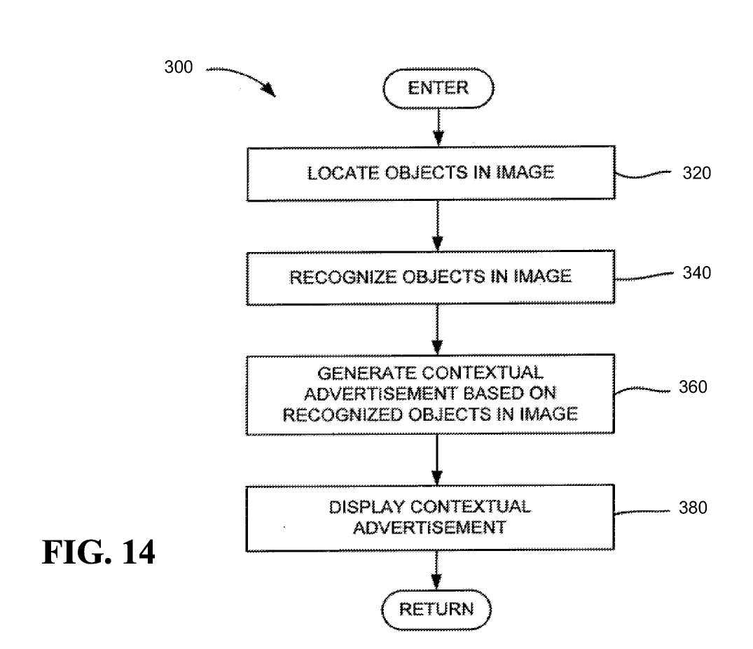

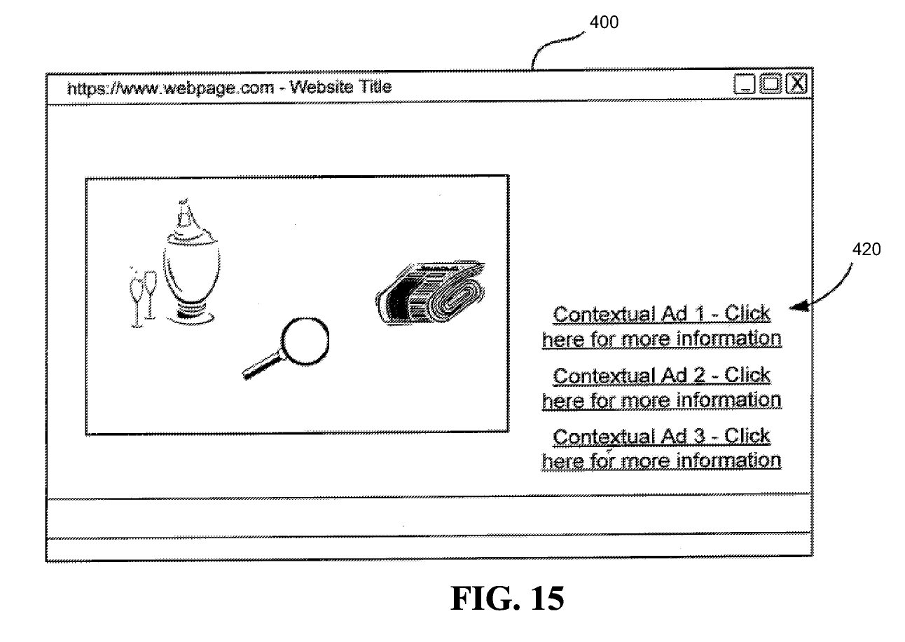

With reference to FIG. 12-15, one or more embodiments may be embodied in method 300 (FIG. 14) for presenting image-based contextual advertisements 420 (FIG. 15). In the method, objects (FIG. 12) are located in an image 120 (step 320) on a webpage 100. The located objects (FIG. 13) are recognized using image recognition techniques (step 340). Contextual advertisements 420 are generated based on the recognized objects in the image (step 360). The contextual advertisements 420 are displayed on the web page 400 (step 380).

In a more detailed description, the image 120 may display a magnifying glass, a newspaper, and a pitcher and glasses. The contextual advertisement 420 may be directed to the website of a merchant selling magnifying glasses, or to the website of a newspaper. Further, in one or more embodiments, the contextual advertisements can be part of a context sensing program that rewards website content providers with revenue for the advertisements.

From a usability standpoint, it is important to let camera phone users know that certain media contains images/text associated with back-end server advertisement or other information. In other words, in the absence of some additional information about the availability of the back-end server, it may not always be readily apparent to a user that certain media can be scanned and information retrieved based thereon. In these circumstances, the user does not obtain the benefit of being able to access the additional information from the back-end server. Accordingly, to overcome this problem, one or more embodiments provide a mechanism/technique by which the user can be made aware of the scannability of certain media by including particular indicia on some media to indicate that that particular media contains images/text is associated with back-end retrievable information, and that an image thereof can be transmitted to a back-end server to retrieve such information. The presence of the indicia associated with a back-end server thus signal to the user both the availability of the additional information, as well as the particular mechanism or means by which the information can be retrieved.

The content medium on which images and barcodes are placed in accordance with one or more embodiments may vary. For example, the content medium may be a printed document (print media) such as a newspaper, magazine, book, or a brochure. In another example, the content medium may be product packaging (e.g., a liquid bottle, a food box, a box used for packaging). In still another example, the content medium may be a surface of an article of manufacture (e.g., a barcode marked with indicia on a surface of a computer).

Further, one or more of various types of barcodes may be used in one or more embodiments. For example, barcodes may be one or more of the following known types: EAN-13; EAN-8, EAN Bookland; UPC-A; UPC-E; Code 11; UPC Shipping Contained Code; Interleaved 2 of 5; Industrial 2 of 5; Standard 2 of 5; Codabar (USD-4, NW-7, 2 of 7); Plessey; MSI (MSI Plessey); OPC (Optical Industry Association); Postnet; Code 39; Code 93; Extended Code 39; Code 128; UCC/EAN-128; LOGMARS; PDF-417; DataMatrix; Maxicode; and QR Code.

The indicia, in one or more embodiments, may be a branded barcode. In other words, a scannable barcode may have adjacent to it some particular branding that would inform a user that the media contains images/text that can be scanned to retrieve information using an entity associated with the particular branding. In one or more embodiments, the branding comprises indicia indicating a name, identity, mark, or logo associated with a back-end server.

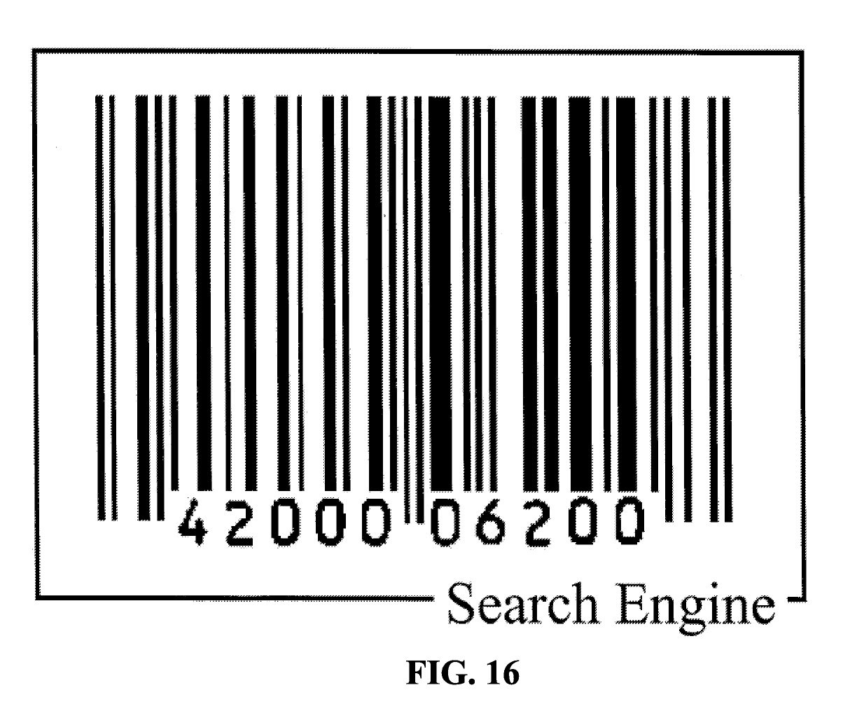

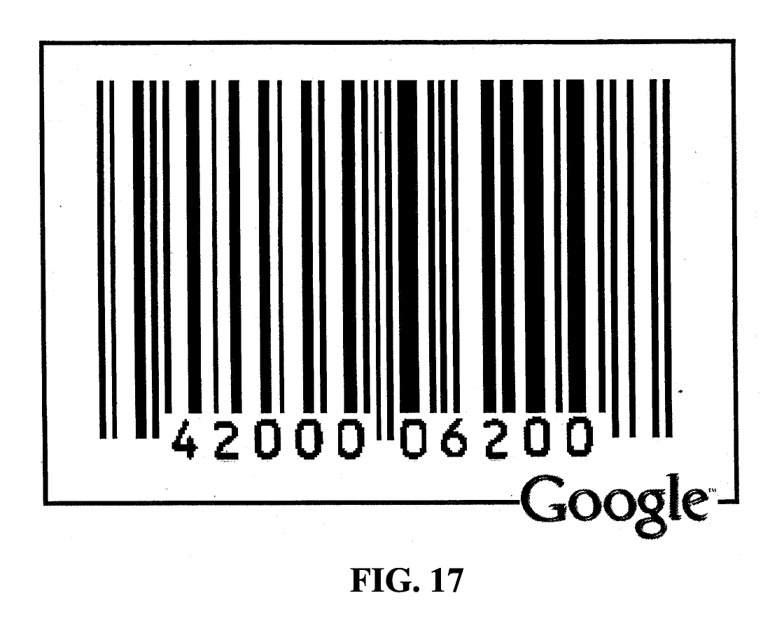

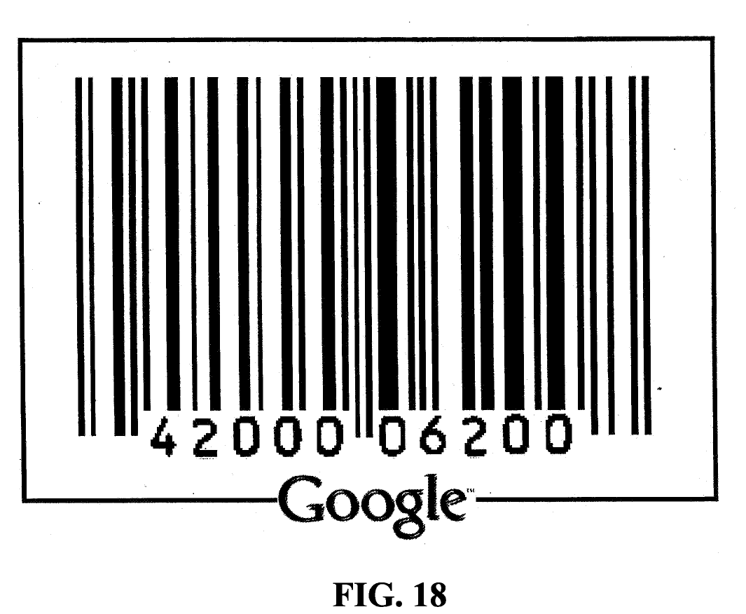

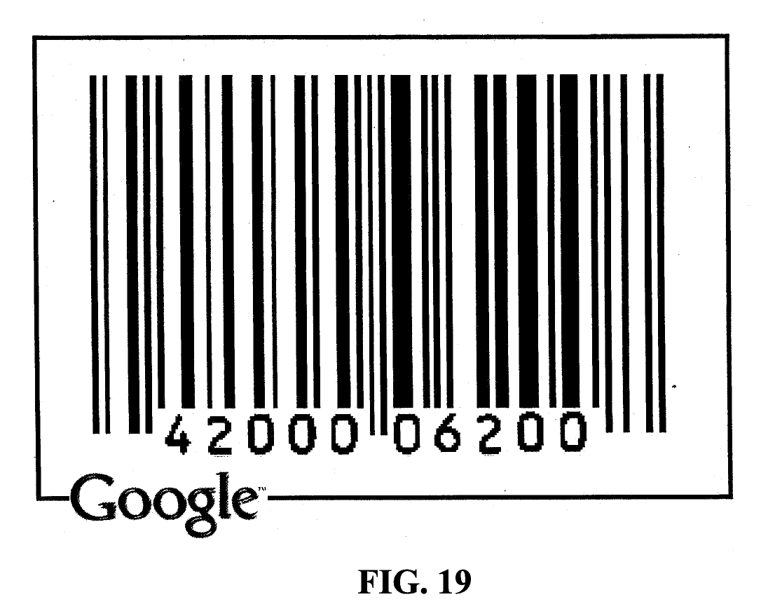

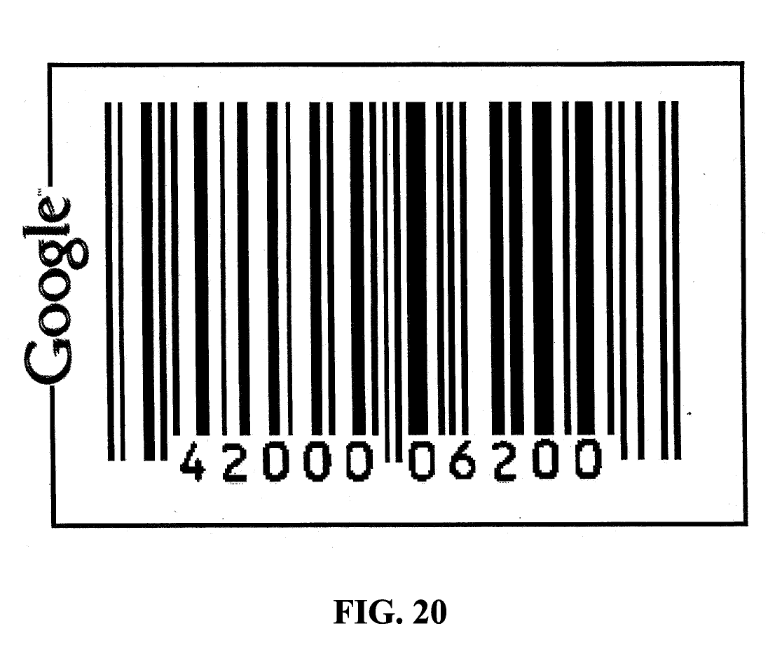

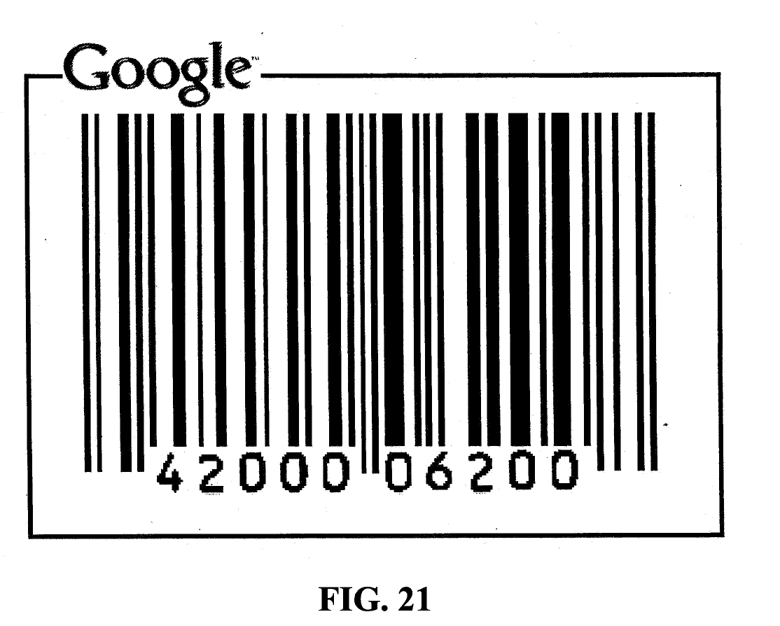

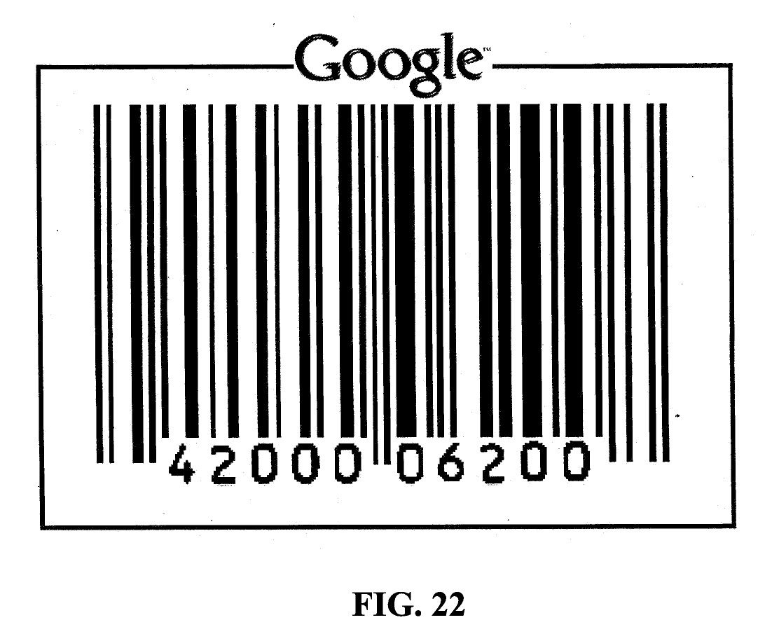

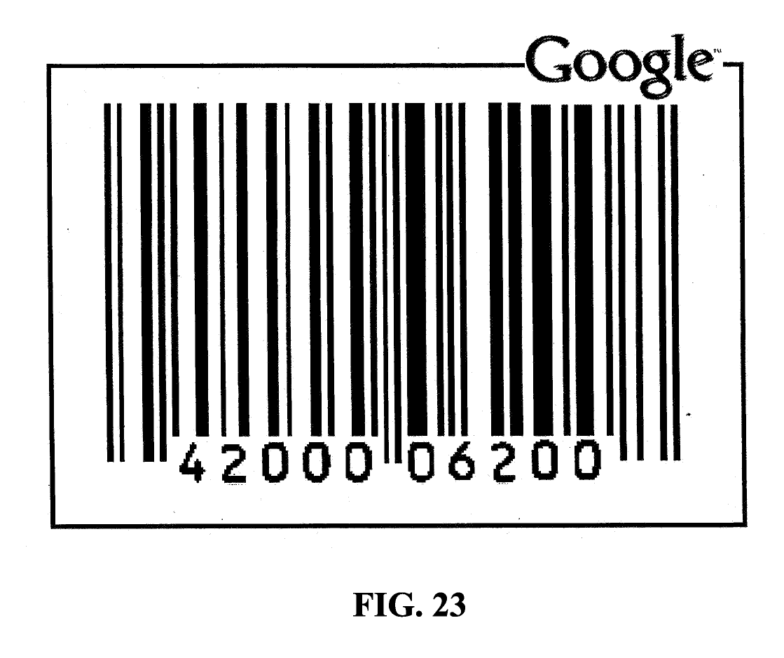

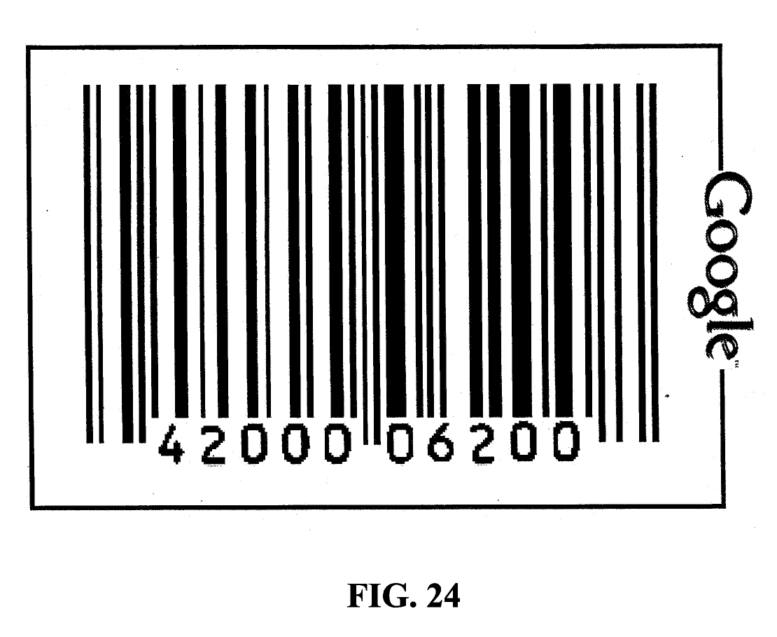

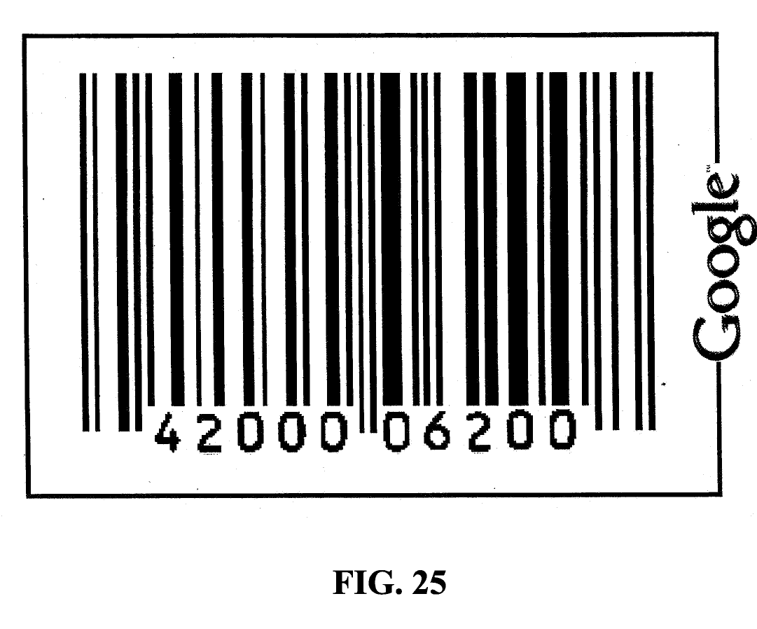

With reference to FIGS. 16-25, barcodes placed on products (and similar objects) are branded providing an indication that an image search or a product search may be performed using a search engine, such as an image search engine, associated with the brand. Particularly, for example, in FIGS. 17-25, the barcodes are branded with the name of the search engine Google, thereby indicating to the user that images/text on the media having the barcode are associated with additional information, and that an image of the barcode (taken, e.g., with a camera, cell phone, or other image capture device) may be transmitted to the Google search engine in order to retrieve such information.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It should be noted that the methods described herein may be implemented on a variety of communication hardware, processors and systems known by one of ordinary skill in the art. For example, the general requirement for the client to operate as described herein is that the client has a display to display content and information, a processor to control the operation of the client and a memory for storing data and programs related to the operation of the client. In one embodiment, the client is a cellular phone. In another embodiment, the client is a handheld computer having communications capabilities. In yet another embodiment, the client is a personal computer having communications capabilities. In addition, hardware such as a GPS receiver may be incorporated as necessary in the client to implement the various embodiments described herein. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, e.g., in an instant messaging service or any general wireless data communication applications, without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

While the invention has been described with respect to a limited number of embodiments, those skilled in the art, having benefit of the above description, will appreciate that other embodiments may be devised which do not depart from the scope of the present invention as described herein. Accordingly, the scope of the present invention should be limited only by the appended claims.

What is claimed is:

1. A method, comprising:
generating a non-electronic content medium with at least one image, including:
determining whether the at least one image is associated with information stored in a remote system, and
providing on the content medium a barcode scannable by an image capture device, wherein the barcode is marked with indicia designating a source of the information.

2. The method of claim 1, wherein the image capture device comprises a mobile phone.

3. The method of claim 1, wherein the indicia comprises at least one of a brand, a name, an identity marking, a mark, and a logo.

4. The method of claim 1, wherein the indicia comprises an indication of a search engine system adapted to receive the at least one image scanned by the image capture device.

5. The method of claim 1, wherein providing the barcode on the content medium comprises:
positioning the indicia to the right of the barcode.

6. The method of claim 1, wherein providing the barcode on the content medium comprises:
positioning the indicia to the left of the barcode.

7. The method of claim 1, wherein providing the barcode on the content medium comprises:
positioning the indicia above the barcode.

8. The method of claim 1, wherein providing the barcode on the content medium comprises:
positioning the indicia below the barcode.

9. The method of claim 1, wherein the content medium is a printed document.

10. The method of claim 1, wherein the content medium is product packaging.

11. The method of claim 1, wherein the content medium is a surface of an article of manufacture.

12. The method of claim 1, wherein the at least one image comprises text.

13. A printed content medium, comprising
at least one image associated with externally stored information; and
a barcode marked with indicia to indicate a source of the information,
wherein the at least one image is scannable by an image capture device to retrieve the information from the source.

14. The content medium of claim 13, wherein the content medium comprises one of a printed publication and print media.

15. The content medium of claim 13, wherein the at least one image comprises text.

16. The content medium of claim 13, wherein the image capture device comprises a camera phone.

17. The content medium of claim 16, wherein the information is externally stored in the camera phone.

18. The content medium of claim 13, wherein the indicia comprises at least one of a brand, a name, an identity marking, a mark, and a logo.

19. The content medium of claim 13, wherein the indicia is positioned to the right of the barcode.

20. The content medium of claim 13, wherein the indicia is positioned to the left of the barcode.

21. The content medium of claim 13, wherein the indicia is positioned above the barcode.

22. The content medium of claim 13, wherein the indicia is positioned below the barcode.

23. The content medium of claim 13, wherein the content medium is product packaging.

24. The content medium of claim 13, wherein the content medium is a surface of an article of manufacture.
